(19) United States
(12) Patent Application Publication
(10) Pub. No.: US 2011/0023627 A1
(43) Pub. Date: Feb. 3, 2011

(54) METHOD AND DEVICE FOR PROVIDING A TORSION ELEMENT OF A TORQUE SENSOR WITH MAGNETIZATION

(76) Inventors: Ingo Herrmann, Friolzheim (DE); Frank Schatz, Kornwestheim (DE)

Correspondence Address: KENYON & KENYON LLP, ONE BROADWAY, NEW YORK, NY, 10004, US

(21) Appl. No.: 12/734,875

(22) PCT Filed: Oct. 23, 2008
(86) PCT No.: PCT/EP2008/064334

§ 371 Date: Oct. 4, 2010

(30) Foreign Application Priority Data
Dec. 12, 2007 (DE) 10 2007 059 902.3

(51) Int. Cl. G01L 3/10

(52) U.S. Cl. 73/862.331; 73/862.337

(57) ABSTRACT

The present invention relates to a method for providing a one- or multipart torsion element of a torque sensor with at least one magnetic encoding by applying at least one current pulse to the torsion element. It is provided that the variation of the current pulse over time is formed. Moreover, the present invention relates to a device for providing a one- or multipart torsion element of a torque sensor with at least one magnetic encoding.

### BACKGROUND OF THE INVENTION

1. Field of the Invention

The present invention relates to method and device for providing a torsion element of a torque sensor with magnetization.

2. Description of Related Art

A torque sensor is known from US 2005/0193834 A1, the torsion element of which is provided with a magnetic encoding. A magnetic field sensor is associated with the torsion element, and may be used to detect a change in a magnetic field resulting from twisting the magnetized torsion element. The torque acting on the torsion element may be ascertained from the measured values of the magnetic field sensor, using a suitable electronics system. For the known torque sensor, the magnetic encoding, i.e., the magnetization, is produced by applying at least one current pulse to the torsion element. The variation of the current pulse over time behaves as an e-function.

### SUMMARY OF THE INVENTION

The object of the present invention is to provide a method and a device with which the distribution of the magnetization in the torsion element may be set more precisely. By use of the method and the device, a stronger magnetization of the torsion element is preferably achievable at the same or lower current intensities.

The present invention is based on the concept of forming the variation over time of a current pulse generated by at least one current source, preferably by at least one capacitor, in particular in such a way that the stability and/or the intensity of the at least one magnetic encoding, i.e., the at least one magnetization, is increased. The aim in particular is to thus enhance the usability of the magnetic encoding with regard to improved evaluability and detectability. In one particularly preferred specific embodiment, the torsion element is magnetized with the aid of at least two oppositely oriented current pulses, preferably in such a way that magnetizations are achieved in different regions, preferably in two counter-rotating shells of the torsion element. It is particularly preferred to form the variation over time of all current pulses, i.e., to optimize with regard to the stability and intensity of the magnetizations to be achieved. With respect to a possible design of the torque sensor, in particular the one- or multipart torsion element, and with respect to application variants of the at least one current pulse, for example by providing multiple electrodes interspaced in the circumferential direction, reference is made to US 2005/0193834 A1, the disclosure of which is considered to be incorporated into the present disclosure, so that at least one arbitrary feature of the present application together with at least one arbitrary feature of the cited document is intended to be combinable and claimable.

In one refinement of the present invention, it is advantageously provided that the variation of the current pulse over time is formed in such a way that the steepness of the leading edge of the current pulse, i.e., the slew rate, is reduced, preferably in its entirety, at least in one section. Due to the slowed rise in current, the current pulse is able to penetrate more deeply into the torsion element in the radial direction (“skin effect”), so that more Weiss domains are aligned, resulting in stronger magnetization at the same or even lower current intensities. Additionally or alternatively, the variation of the current pulse over time may be formed in such a way that the steepness of the rising current edge is increased, at least in one section, in particular in an edge section immediately before the maximum current is reached, in order to thus achieve a low current penetration depth in the radial direction (skin effect), resulting in a very strong and very thin magnetization shell, which may be of considerable advantage for some applications.

In one particularly advantageous specific embodiment of the present invention, the leading edge is deformed in at least one section in such a way that the leading edge is at least approximately linear; i.e., the current intensity increases linearly, not exponentially, over time, in particular in order to reduce the rate of current rise in a middle time segment, and to increase the rate of current rise before the current maximum is reached.

In one refinement of the present invention, it is advantageously provided that the at least one current pulse is applied in such a way that it runs along the longitudinal extension of the torsion element, at least over one longitudinal section of the torsion element. The at least one current pulse is preferably led in and/or out at an axial distance from the ends of the torsion element.

In one particularly advantageous specific embodiment, the current intensity of the current pulse is selected from a value range between approximately 40 amperes and approximately 1400 amperes. Additionally or alternatively, the duration of the current pulse, i.e., the time period, is selected from a value range between approximately 10 microseconds and approximately 300 milliseconds.

In addition to the previously described method, the present invention also relates to a device for providing a one- or multipart torsion element of a torque sensor with at least one magnetic encoding by applying at least one current pulse to the torsion element, the device having at least one current source for generating at least one current pulse. Multiple current sources are preferably provided for generating simultaneous or time-delayed multiple current pulses. Alternatively, multiple current pulses may be generated in a time-delayed manner using only one current source. The device is particularly preferably used to simultaneously or successively generate two oppositely oriented current pulses for producing two stable magnetizations in two counter-rotating shells of the torsion element. The device designed according to the concept of the present invention includes means for forming the variation of at least one current pulse over time, thus allowing the stability and the intensity of the at least one resulting magnetic field to be positively influenced.

In one particularly advantageous specific embodiment, the current source for generating the at least one current pulse is designed as a capacitor system having at least one capacitor or including such a capacitor system, the current pulse being formed by the discharge current of the capacitor system. If the means according to the present invention for forming the variation of the current pulse over time were not provided, the variation of the current pulse over time in a current source having such a design would correspond to an e-function, or to a function composed of multiple e-functions.

The means for forming the variation of the at least one current pulse over time are advantageously situated in the electric circuit, between the current source and the torsion element and/or between the torsion element and the current source. The means for forming the variation over time may be composed of multiple individual components, which preferably are connected in series.

In one particularly advantageous specific embodiment of the device, the means for forming the variation over time are designed in such a way that by use of same the steepness of the leading edge of the current pulse may be reduced, at least in one time segment. Additionally or alternatively, the means are particularly preferably designed in such a way that by use of same the variation of the current pulse over time may be linearized at least in one section.

In one preferred specific embodiment, the means for forming the variation of the current pulse over time include at least one electrical element which causes the current intensity to increase nonlinearly when acted upon by current. The electrical element is particularly preferably at least one inductor. When multiple electrical elements of this type are provided, they are preferably connected in series.

In one particularly advantageous specific embodiment, the at least one inductor is formed by at least one coil, in particular a ring coil, having a coil core (core). When multiple coils are used, they are preferably connected in series.

Particularly good results with regard to the stability and intensity of the obtained magnetic encoding are achieved when the core of the at least one coil is designed in such a way that it is saturated as quickly as possible, since the rate of current increase is thus minimized in at least one, in particular middle, section, and is increased in a time segment immediately before the current maximum is reached. It is also possible to combine multiple core materials having different saturation field intensities.

Moreover, the present invention relates to use of a previously described device for providing a one- or multipart torsion element of a torque sensor with at least one magnetic encoding. For example, the device may be designed in such a way that by use of the device the variation over time of only one current pulse may be influenced, or in such a way that the variation over time of a portion of the current pulses used may be influenced, or preferably in such a way that the variation over time of all current pulses used may be influenced, as previously described.

Further advantages, features, and particulars of the present invention result from the following description of preferred exemplary embodiments, with reference to the drawings.

### BRIEF DESCRIPTION OF THE SEVERAL VIEWS OF THE DRAWINGS

FIG. 1 shows a highly schematic illustration of a device for magnetizing a torsion element of a torque sensor.

FIG. 2 shows a diagram illustrating the variation of a current pulse over time according to the related art, and also the variation of a current pulse over time after appropriate forming.

### DETAILED DESCRIPTION OF THE INVENTION

Identical components and identical elements, as well as components and elements having the same function, are denoted by the same reference numerals in the figures.

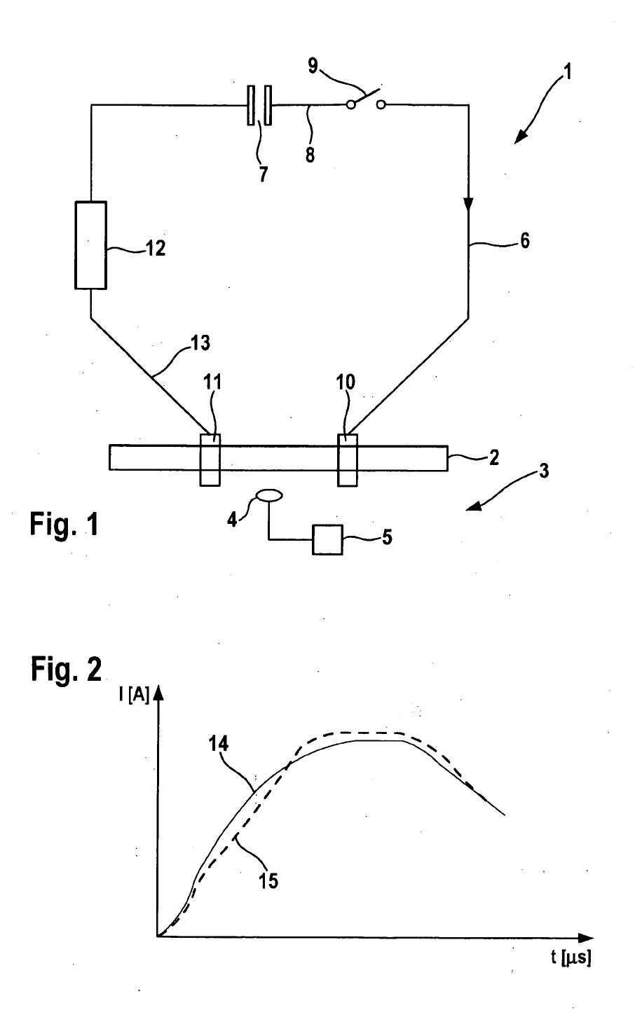

FIG. 1 shows a device 1 for applying magnetization (magnetic encoding) to a torsion element 2 of a torque sensor 3. In the exemplary embodiment shown, torsion element 2 is designed as a one-piece torsion bar. Torsion element 2 may also have a multipart and/or a variably contoured design. In addition to torsion element 2, which is twisted by a torque to be measured, torque sensor 3 includes (at least) one magnetic field sensor 4, a Hall sensor, for example, which is connected to an evaluation electronics system 5, which measures the torque present on torsion element 2 based on the values measured by magnetic field sensor 4.

In order to provide torsion element 2 with magnetization, device 1 includes an electric circuit 6 having a current source 7, which in the exemplary embodiment shown is formed by a capacitor. An electrical line 8 leads from current source 7 to a switch 9, and from there to a first electrode 10 through which a current pulse (discharge current pulse) is able to flow into torsion element 2. First electrode 10 is situated at an axial distance from the two ends of torsion element 2. Offset at an axial distance from first electrode 10 is a second electrode 11, through which the current pulse is able to flow via a line 13 to means 12 for forming the variation of the current pulse over time, and via the line back to current source 7. Means 12 are composed, for example, of at least one ring coil having a core (not shown), the core being made of a material which is quickly magnetically saturated, so that the variation of the current pulse over time may be influenced in such a way that a comparatively slow rate of current increase and an at least approximately linear variation of the current pulse over time result.

As soon as electric circuit 6 is closed by actuating switch 9, a current pulse generated by the discharge of the capacitor of current source 7 flows to torsion element 2, and flows therein in the longitudinal direction to second electrode 11 which is situated at an axial distance from the ends of torsion element 2, and from there to means 12. As a result of the current pulse, which in this exemplary embodiment has an intensity of approximately 900 amperes and a duration of approximately 100 ms, torsion element 2 is provided with a magnetic encoding in one section. Additional, preferably opposite, magnetizations may likewise be achieved, for example by applying at least one additional current pulse simultaneously or time-delayed; the current pulse may be applied using device 1 shown, or a device 1 having a similar design. It is also possible to not form the variation over time of the at least one additional current pulse.

The action of means 12 according to FIG. 1 is shown in FIG. 2. The variation of a current pulse 14 over time according to the related art is shown in a diagram in which current intensity I of the current pulse over time is plotted.

It is apparent that the curve behaves as an e-function. The variation of a current pulse 15 over time according to the present invention is shown by a dashed line. It is apparent that the rise is practically linear, the slew rate in a middle time segment being reduced compared to a current pulse according to the related art. It is also apparent that the maximum current intensity of current pulse 15 is greater than the maximum of current pulse 14, and that the rate of current increase in a time segment following the middle time segment, immediately before the current maximum is reached, is greater than for current pulse 14, in order to achieve a low penetration depth and thus a strong magnetization in a thin shell at maximum current.

1-15. (canceled)

16. A method for providing a one- or multipart torsion element of a torque sensor with at least one magnetic encoding, comprising: applying at least one current pulse to the torsion element, and varying the current pulse over time.

17. The method as recited in claim 16, wherein steepness of a leading edge of the current pulse is reduced or increased, at least in sections.

18. The method as recited in claim 17, wherein steepness of a leading edge of the current pulse is reduced or increased, at least in sections, in a time segment immediately before a current maximum is reached.

19. The method as recited in claims 16, wherein a leading edge of the current pulse is at least approximately linearized, at least in sections.

20. The method as recited in claims 17, wherein a leading edge of the current pulse is at least approximately linearized, at least in sections.

21. The method as recited in claim 16, wherein the current pulse is applied in such a way that it runs along a longitudinal extension of the torsion element.

22. The method as recited in claim 17, wherein the current pulse is applied in such a way that it runs along a longitudinal extension of the torsion element.

23. The method as recited in claim 16, wherein the current intensity of the current pulse is selected from a value range between approximately 40 A and approximately 1400 A, or the duration of the current pulse is selected from a value range between approximately 10 microseconds and approximately 300 milliseconds.

24. The method as recited in claim 17, wherein the current intensity of the current pulse is selected from a value range between approximately 40 A and approximately 1400 A, or the duration of the current pulse is selected from a value range between approximately 10 microseconds and approximately 300 milliseconds.

25. A device for providing a one- or multipart torsion element of a torque sensor with at least one magnetic encoding by applying at least one current pulse to the torsion element, the device comprising: at least one current source for generating a current pulse, and means for varying the current pulse over time.

26. The device as recited in claim 25, wherein the current source for generating the current pulse includes a capacitor system having at least one capacitor.

27. The device as recited in claim 25, wherein the means for varying the current pulse over time is situated between the current source and the torsion element.

28. The device as recited in claim 25, wherein the means for varying reduces steepness of a leading edge of the current pulse, at least in sections.

29. The device as recited in claim 25, wherein the means for varying varies the current pulse approximately linearly over time, at least in sections.

30. The device as recited in claim 25, wherein the means for varying includes at least one electrical element having a nonlinear current rise characteristic.

31. The device as recited in claim 25, wherein the means for varying includes at least one inductor.

32. The device as recited in claim 31, wherein the inductor has at least one ring coil, having at least one core.

33. The device as recited in claim 32, wherein the core is designed in such a way that it is magnetically saturated before a current pulse maximum is reached.
